(19) United States
(12) Patent Application Publication
(10) Pub. No.: US 2017/0150208 A1
(43) Pub. Date: May 25, 2017

(54) AUDIO AND VIDEO PLAYING DEVICE AND METHOD

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Wei LIU, Tianjin (CN)

(21) Appl. No.: 15/239,932

(22) Filed: Aug. 18, 2016

Related U.S. Application Data
(63) Continuation of application No. PCT/CN2016/082501, filed on May 18, 2016.

(30) Foreign Application Priority Data
Nov. 20, 2015 (CN) 201510811498.4

(51) Int. Cl. H04N 21/4363; H04N 21/439; H04N 21/4402

(52) U.S. Cl. CPC H04N 21/43635; H04N 21/4402; H04N 21/4398

(57) ABSTRACT

Disclosed is an audio and video playing device and method, and the audio and video playing device includes a processor system and a display system, wherein the processor system is configured to wirelessly transmit data in the High Definition Multimedia Interface (HDMI) format to the display system; and the display system is configured to receive wirelessly the data in the HDMI format transmitted by the processor system, and to play audio and video based upon the wirelessly received data in the HDMI format. The audio and video playing device according to an embodiment of the disclosure can be upgraded in hardware by upgrading the processor system or the display system separately conveniently, thus improving the operability thereof so as to address the problem in the prior art of poor operability of the audio and video playing device being upgraded in hardware.

### CROSS REFERENCE TO RELATED APPLICATIONS

This application is a continuation of International Application No. PCT/CN2016/082501, filed on May 18, 2016, which is based upon and claims priority to Chinese Patent Application No. 201510811498.4, filed on Nov. 20, 2015, the entire contents of which are incorporated herein by reference.

### TECHNICAL FIELD

The present disclosure relates to the field of multimedia playing, and particularly to an audio and video playing device.

### BACKGROUND

Respective component systems of some existing audio and video playing devices, e.g., smart TV, etc., are generally integrated together, so one of the component systems in the audio and video playing device has to be upgraded in hardware by dissembling the audio and video playing devices, thus degrading the operability thereof.

### SUMMARY

The disclosure provide an audio and video playing device and method so as to upgrade in hardware the audio and video playing device conveniently, thus improving the operability thereof.

An embodiment of the disclosure provides an audio and video playing device including a processor system and a display system, wherein:

the processor system is configured to wirelessly transmit data in the High Definition Multimedia Interface (HDMI) format to the display system; and

the display system is configured to receive wirelessly the data in the HDMI format transmitted by the processor system, and to play audio and video based upon the wirelessly received data in the HDMI format.

Based upon the same inventive concept, an embodiment of the disclosure provides an audio and video playing method including:

wirelessly transmitting, by a processor system of an audio and video playing device, data in the High Definition Multimedia Interface (HDMI) format to a display system of the audio and video playing device; and

wirelessly receiving, by the display system, the data in the HDMI format transmitted wirelessly by the processor system, and playing audio and video based upon the wirelessly received data in the HDMI format.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a first schematic structural diagram of an audio and video playing device according to some embodiments of the disclosure;

FIG. 2 is a second schematic structural diagram of an audio and video playing device according to some embodiments of the disclosure;

FIG. 3 is a third schematic structural diagram of an audio and video playing device according to some embodiments of the disclosure;

FIG. 4 is a fourth schematic structural diagram of an audio and video playing device according to some embodiments of the disclosure; and

FIG. 5 is a flow chart of steps in an audio and video playing method according to some embodiments of the disclosure.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

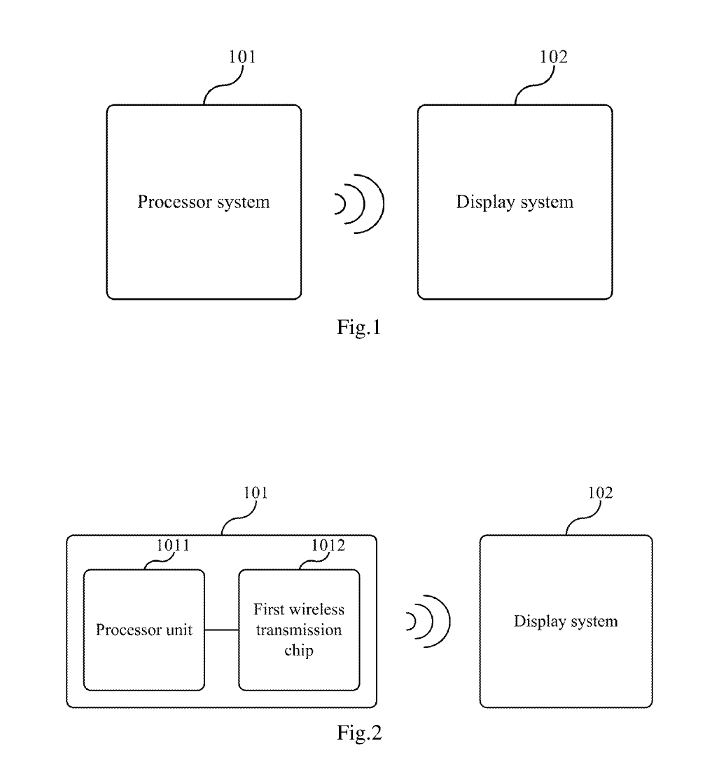

Some existing audio and video playing devices, e.g., a smart TV set, etc., are generally upgraded in hardware by upgrading their processors, so an audio and video playing device according to an embodiment of the disclosure as illustrated in FIG. 1 can include two components which are a processor system 101 and a display system 102, where:

The processor system 101 is configured to wirelessly transmit data in the High Definition Multimedia Interface (HDMI) format to the display system 102; and

The display system 102 is configured to receive wirelessly the data in the HDMI format transmitted by the processor system 101, and to play audio and video based upon the wirelessly received data in the HDMI format.

Particularly the processor system 101 can generate based upon an external signal or data and transmit wirelessly the data in the HDMI format to the display system 102, and the display system 102 can process the data in the HDMI format, and obtain and play audio data and video data.

That is, in the audio and video playing device according to the embodiment of the disclosure, the two components which are the processor system 101 and the display system 102 communicate wirelessly, and the audio and video playing device can be upgraded in hardware by upgrading the processor system 101 or the display system separately, so the audio and video playing device according to the embodiment of the disclosure can be upgraded in hardware conveniently as compared with the prior art.

It shall be noted that the audio and video playing device according to the embodiment of the disclosure can particularly include but will not be limited to a smart TV set, a DVD player, or another audio and video device.

If the audio and video playing device according to the embodiment of the disclosure is particularly a smart TV set, then the processor system 101 will receive and process an analog/digital TV signal, and obtain and transmit wirelessly the data in the HDMI format to the display system 102, and the display system 102 will process the data in the HDMI format, and obtain and play the audio data and the video data, thus enabling a TV program to be played.

If the audio and video playing device according to the embodiment of the disclosure is particularly a DVD player, then the processor system 101 will read and process DVD data, and obtain and transmit wirelessly the data in the HDMI format to the display system 102, and the display system 102 will process the data in the HDMI format, and obtain and play the audio data and the video data, thus enabling a DVD to be played.

In a particular embodiment of the disclosure, the processor system 101 can include a processor unit 1011 and a first wireless transmission chip 1012, particularly as illustrated in FIG. 2, where:

The processor unit 1011 is configured to generate the data in the HDMI format;

The first wireless transmission chip 1012 is configured to transmit wirelessly the data in the HDMI format generated by the processor unit 1011.

Particularly the processor unit 1011 can be embodied particularly by any one of a number of processors in the prior art.

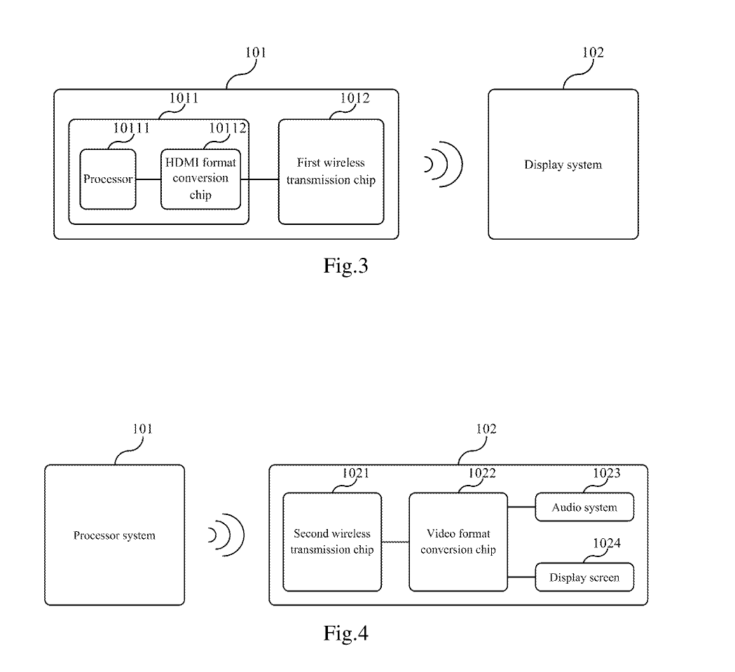

If the processor embodying the processor unit 1011 can not output the data in the HDMI format directly, then the processor unit 1011 can particularly include a processor 10111 and an HDMI format converting chip 10112, particularly as illustrated in FIG. 3, wherein:

The processor 10111 is configured to generate the data in a format other than the HDMI format; and

The HDMI format converting chip 10112 is configured to convert the data in the format other than the HDMI format generated by the processor 10111 into the data in the HDMI format.

For example, some existing processors output the data in the Low Voltage Differential Signaling (LVDS), and at this time, the HDMI format converting chip can convert the data in the LVDS format output by the processor into the data in the HDMI format.

If the processor embodying the processor unit 1011 can output the data in the HDMI format directly, then the processor unit 1011 will not include the HDMI format converting chip.

Typically the processor in the processor unit 1011 can generate the data in the HDMI format or the data in the format other than the HDMI format based upon an external audio and video signal, particularly as in the prior art, so a detailed description thereof will be omitted here.

Furthermore the first wireless transmission chip 1012 can be particularly a wireless transmission chip with an operating band of 60 GHz and a high data transmission rate. Of course, the first wireless transmission chip 1012 can alternatively be another type of wireless transmission chip, and the embodiment of the disclosure will not be limited to any particular type of wireless transmission chip.

The particular implementation above of the processor system 101 has been described only as an example, and in another particular embodiment of the disclosure, the processor system 101 can be embodied otherwise, although a detailed description thereof will be omitted here.

In a particular embodiment of the disclosure, the display system 102 can include a second wireless transmission chip 1021, a video format converting chip 1022, an audio system 1023, and a display screen 1024, particularly as illustrated in FIG. 4, where:

The second wireless transmission chip 1021 is configured to receive wirelessly the data in the HDMI format;

The video format converting chip 1022 is configured to output the audio data of the data in the HDMI format received wirelessly by the second wireless transmission chip to the audio system 1023; and to convert the video data of the data in the HDMI format received wirelessly by the second wireless transmission chip into the video data in a format that can be identified by the display screen 1024, and to transmit the converted video data to the display screen 1024;

The audio system 1023 is configured to play the audio data output by the video format converting chip 1022; and

The display screen 1024 is configured to play the video data output by the video format converting chip 1022.

Furthermore the second wireless transmission chip 1021 is particularly a wireless transmission chip with an operating band of 60 GHz and a high data transmission rate. Of course, the second wireless transmission chip 1021 can alternatively be embodied by another type of wireless transmission chip, and the embodiment of the disclosure will not be limited to any particular type of wireless transmission chip.

A format that can be identified by an existing display screen is generally the V-by-One format, so the video format converting chip 1022 can be particularly an HDMI to V-by-One video format converting chip; and at this time, the video format converting chip 1022 can convert the video data of the data in the HDMI format received by the second wireless transmission chip 1021 into the data in the V-by-One format, and output the data in the V-by-One format to the display screen 1024 for playing.

If the format that can be identified by the display screen 1024 in the display system 102 is another format, e.g., the LVDS format, then the video format converting chip 1022 will be particularly an HDMI to LVDS video format converting chip; and at this time, the video format converting chip 1022 can convert the video data of the data in the HDMI format received by the second wireless transmission chip 1021 into the data in the LVDS format, and output the data in the LVDS format to the display screen 1024 for playing.

That is, the video format converting chip 1022 shall be embodied by a type of chip determined by the format that can be identified by the display screen 1024 in a real application.

The particular implementation above of the display system 102 has also been described only as an example, and in another particular embodiment of the disclosure, the display system 102 can be embodied otherwise, although a detailed description thereof will be omitted here.

It shall be noted that the embodiment of the disclosure will not be limited to any particular mode in which the processor system 101 and the display system 102 in the audio and video playing device according to the embodiment of the disclosure are powered.

In a particular embodiment of the disclosure, mains supply can be input respectively to the processor system 101 and the display system 102 to power them separately.

In another particular embodiment of the disclosure, mains supply can be input to only the processor system 101, and at this time, the processor system 101 can be provided with a power output interface via which the processor system 101 is connected with the display system 102 to power the display system 102.

In another particular embodiment of the disclosure, mains supply can be input to only the display system 102, and at this time, the display system 102 can be provided with a power output interface via which the display system 102 is connected with the processor system 101 to power the processor system 101.

In a real application, the power output interface in the two particular embodiments above can be a plug power output interface, or can be a contact power source interface.

In summary, the audio and video playing device according to the embodiment of the disclosure can be upgraded in hardware conveniently, thus improving the operability and easiness-to-implement thereof, and lower significantly the cost thereof.

In at least one embodiment, the processor system 101 in the audio and video playing device according to the embodiment of the disclosure can be further provided with a display screen so that if the processor system 101 is not transmitting any data in the HDMI format to the display system 102, then the processor system 101 can also operate as a separate intelligent device to thereby improve the utilization ratio of the audio and video playing device.

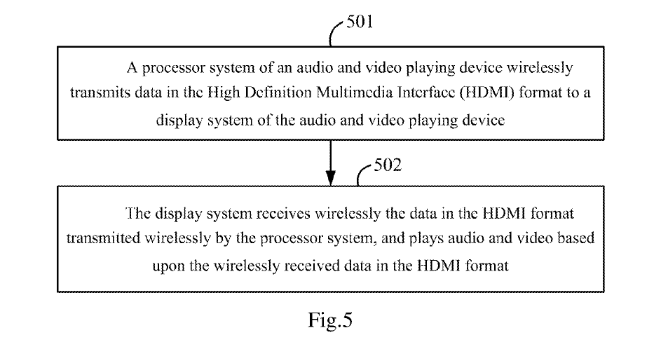

Based upon the same inventive concept, an embodiment of the disclosure further provides an audio and video playing method as illustrated in FIG. 5, where the method can include the following steps:

In the step 501, a processor system of an audio and video playing device wirelessly transmits data in the High Definition Multimedia Interface (HDMI) format to a display system of the audio and video playing device; and

In the step 502, the display system receives wirelessly the data in the HDMI format transmitted wirelessly by the processor system, and plays audio and video based upon the wirelessly received data in the HDMI format.

Optionally, in the step 501, the processor system of the audio and video playing device can transmit wirelessly the data in the HDMI format to the display system of the audio and video playing device particularly as follows:

The processor system generates the data in the HDMI format; and

The processor system transmits wirelessly the generated data in the HDMI format.

Furthermore the processor system can generate the data in the HDMI format particularly as follows:

The processor system generates the data in a format other than the HDMI format; and

The processor system converts the generated data in the format other than the HDMI format into the data in the HDMI format.

In at least one embodiment, the processor system can transmit wirelessly the generated data in the HDMI format particularly as follows: the processor system transmits wirelessly the generated data in the HDMI format using a wireless transmission chip with an operating band of 60 GHz.

Optionally, in the step 502, the display system can receive wirelessly the data in the HDMI format transmitted wirelessly by the processor system, and play audio and video based upon the wirelessly received data in the HDMI format particularly as follows.

The display system receives wirelessly the data in the HDMI format; and

The display system outputs audio data of the wirelessly received data in the HDMI format to an audio system of the display system for playing; and/or the display system converts video data of the received data in the HDMI format into the video data in a format that can be identified by a display screen of the display system, and outputs the converted video data to the display screen for playing.

In at least one embodiment, the display system can receive wirelessly the data in the HDMI format particularly as follows: the display system receives wirelessly the data in the HDMI format using a wireless transmission chip with an operating band of 60 GHz.

Particularly the display system can convert the video data of the received data in the HDMI format into the video data in the format that can be identified by the display screen of the display system particularly as follows: the display system converts the video data of the received data in the HDMI format into the data in the V-by-One format using an HDMI to V-by-One video format conversion chip.

Optionally the method can further include powering by the display system the processor via a power output interface with which the display system is provided.

Furthermore the power source interface can be a plug power source interface.

Or the power source interface can be a contact power source interface.

In summary, with the audio and video playing method according to the embodiment of the disclosure, the corresponding audio and video playing device can be upgraded in hardware conveniently, thus improving the operability and easiness-to-implement thereof, and lower significantly the cost thereof.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. An audio and video playing device, comprising a processor system and a display system, wherein:
the processor system is configured to wirelessly transmit data in the High Definition Multimedia Interface, HDMI, format to the display system; and
the display system is configured to receive wirelessly the data in the HDMI format transmitted by the processor system, and to play audio and video based upon the wirelessly received data in the HDMI format.

2. The audio and video playing device according to claim 1, wherein the processor system comprises a processor unit and a first wireless transmission chip, wherein:
the processor unit is configured to generate the data in the HDMI format; and
the first wireless transmission chip is configured to transmit wirelessly the data in the HDMI format generated by the processor unit.

3. The audio and video playing device according to claim 2, wherein the processor unit comprises a processor and an HDMI format conversion chip, wherein:
the processor is configured to generate the data in a format other than the HDMI format; and
the HDMI format conversion chip is configured to convert the data in the format other than the HDMI format generated by the processor into the data in the HDMI format.

4. The audio and video playing device according to claim 2, wherein the first wireless transmission chip is a wireless transmission chip with an operating band of 60 GHz.

5. The audio and video playing device according to claim 1, wherein the display system comprises a second wireless transmission chip, a video format converting chip, an audio system, and a display screen, wherein:
the second wireless transmission chip is configured to receive wirelessly the data in the HDMI format;
the video format converting chip is configured to output audio data of the data in the HDMI format received wirelessly by the second wireless transmission chip to the audio system; and to convert video data of the data in the HDMI format received wirelessly by the second wireless transmission chip into the video data in a format that can be identified by the display screen, and to transmit the converted video data to the display screen;
the audio system is configured to play the audio data output by the video format converting chip; and
the display screen is configured to play the video data output by the video format converting chip.

6. The audio and video playing device according to claim 5, wherein the second wireless transmission chip is a wireless transmission chip with an operating band of 60 GHz.

7. The audio and video playing device according to claim 5, wherein the video format converting chip is an HDMI to V-by-One video format converting chip.

8. The audio and video playing device according to claim 1, wherein the display system is provided with a power output interface via which the display system powers the processor system.

9. An audio and video playing method, comprising:
wirelessly transmitting, by a processor system of an audio and video playing device, data in the High Definition Multimedia Interface, HDMI, format to a display system of the audio and video playing device; and
wirelessly receiving, by the display system, the data in the HDMI format transmitted wirelessly by the processor system, and playing audio and video based upon the wirelessly received data in the HDMI format.

10. The method according to claim 9, wherein wirelessly transmitting, by the processor system of the audio and video playing device, the data in the HDMI format to the display system of the audio and video playing device comprises:
generating, by the processor system, the data in the HDMI format; and
wirelessly transmitting, by the processor system, the generated data in the HDMI format.

11. The method according to claim 10, wherein generating, by the processor system, the data in the HDMI format comprises:
generating the data in a format other than the HDMI format; and
converting the generated data in the format other than the HDMI format into the data in the HDMI format.

12. The method according to claim 10, wherein wirelessly transmitting, by the processor system, the generated data in the HDMI format comprises:
wirelessly transmitting, by the processor system, the generated data in the HDMI format using a wireless transmission chip with an operating band of 60 GHz.

13. The method according to claim 9, wherein wirelessly receiving, by the display system, the data in the HDMI format transmitted wirelessly by the processor system, and playing audio and video based upon the wirelessly received data in the HDMI format comprises:
wirelessly receiving, by the display system, the data in the HDMI format; and
outputting, by the display system, audio data of the wirelessly received data in the HDMI format to an audio system of the display system for playing; and/or converting, by the display system, video data of the received data in the HDMI format into the video data in a format that can be identified by a display screen of the display system, and outputting the converted video data to the display screen for playing.

14. The method according to claim 13, wherein wirelessly receiving, by the display system, the data in the HDMI format comprises:
wirelessly receiving, by the display system, the data in the HDMI format using a wireless transmission chip with an operating band of 60 GHz.

15. The method according to claim 13, wherein converting, by the display system, the video data of the received data in the HDMI format into the video data in the format that can be identified by the display screen of the display system comprises:
converting, by the display system, the video data of the received data in the HDMI format into the data in the V-by-One format using an HDMI to V-by-One video format conversion chip.

16. The method according to claim 9, wherein the method further comprises:
powering, by the display system, the processor system via a power output interface with which the display system is provided.
